(19) United States
(12) Patent Application Publication
(10) Pub. No.: US 2018/0189030 A1
(43) Pub. Date: Jul. 5, 2018

(54) SYSTEMS AND METHODS FOR PROVIDING CONTENT

(71) Applicant: Facebook, Inc., Menlo Park, CA (US)

(72) Inventors: Sahil P. Thaker, San Jose, CA (US); Uzma Hussain Barlaskar, San Francisco, CA (US); Saurabh Gupta, Menlo Park, CA (US)

(21) Appl. No.: 15/396,408

(22) Filed: Dec. 30, 2016

(51) Int. Cl. G06F 7/36; G06F 17/30

(52) U.S. Cl. CPC G06F 7/36; G06F 17/30991; G06F 17/30864

(57) ABSTRACT

Systems, methods, and non-transitory computer-readable media can determine at least a first category of content items and a second category of content items to be included in a content feed for a user. A ranking for content items included in the first category is determined and a ranking for content items included in the second category is also determined. An interface that presents the content feed including one or more ranked content items from the first category and one or more ranked content items from the second category is provided.

### FIELD OF THE INVENTION

The present technology relates to the field of content provision. More particularly, the present technology relates to techniques for providing content items.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

### SUMMARY

Various embodiments of the present disclosure can include systems, methods, and non-transitory computer readable media configured to determine at least a first category of content items and a second category of content items to be included in a content feed for a user. A ranking for content items included in the first category is determined and a ranking for content items included in the second category is also determined. An interface that presents the content feed including one or more ranked content items from the first category and one or more ranked content items from the second category is provided.

In an embodiment, content items included in the first category are at least one of live content items that are being broadcasted through a social networking system, live content items produced by entities to which the user has subscribed, on-demand content items that were previously live content items, on-demand content items that were not previously live content items, or any combination thereof.

In an embodiment, the first category is determined based on information describing the user in a social graph.

In an embodiment, the systems, methods, and non-transitory computer readable media are configured to determine a respective popularity for each content item included in the category among users that share a geographic region with the user and determine an ordering for the content items in the category based at least in part on the respective popularities.

In an embodiment, the systems, methods, and non-transitory computer readable media are configured to determine a respective popularity for each content item included in the category among users located in at least one geographic region that was previously visited by the user and determine an ordering for the content items in the category based at least in part on the respective popularities.

In an embodiment, the systems, methods, and non-transitory computer readable media are configured to determine a respective popularity for each content item included in the category among users that share a set of demographics associated with the user and determine an ordering for the content items in the category based at least in part on the respective popularities.

In an embodiment, the systems, methods, and non-transitory computer readable media are configured to determine a respective popularity of each entity that posted content items that are included in the category and determine an ordering for the content items in the category based at least in part on the respective popularities.

In an embodiment, the popularity of an entity is determined based at least in part on a number of users that have subscribed to the entity through a social networking system.

In an embodiment, the popularity of an entity is determined based at least in part a number of users accessing at least one live content item posted by the entity through a social networking system.

In an embodiment, the systems, methods, and non-transitory computer readable media are configured to determine an order in which the first category and second category will be presented in the content feed based at least in part on the respective content items included in the first category and in the second category.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module configured to provide access to various content items, according to an embodiment of the present disclosure.

FIG. 2 illustrates an example of a video module, according to an embodiment of the present disclosure.

FIG. 3 illustrates an example interface for presenting content items, according to an embodiment of the present disclosure.

FIGS. 4A-B illustrate example interfaces for presenting content items, according to an embodiment of the present disclosure.

FIG. 5 illustrates an example process for providing content items, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Providing Content

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, users can access content through a content provider (e.g., social networking system). Such content may include content items that are stored by the content provider, for example, as on-demand content items (e.g., video on-demand or “VOD”) as well as content items that are being broadcasted live (e.g., live content item or live content stream) through the content provider using various mediums (e.g., Internet broadcasting). In one example, a live content stream can include content that is being captured and streamed live by a user (e.g., a broadcaster). For example, the broadcaster can capture and stream an event (e.g., a live video of the broadcaster, concert, speech, etc.) as part of a live content stream. Such events can be captured using computing devices (e.g., mobile devices with audio and video capture capabilities) and/or standalone devices (e.g., video cameras and microphones). A user (e.g., a viewer) operating a computing device can access the live content stream through the content provider. In response, the content provider encodes and provides data corresponding to the live content stream to the user's computing device over a network (e.g., the Internet) in real-time. The computing device can decode and present the live content stream, for example, through a display screen of the computing device. In general, the live content stream continues to be provided to the user's computing device until the broadcaster discontinues broadcasting the live content stream or the user instructs the computing device to stop accessing the live content stream, for example. In general, there may be a plethora of content items that are available through the content provider for users to access. As a consequence, providing users with recommendations for relevant live and/or on-demand content items can be challenging. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, the content provider (e.g., social networking system) is configured to determine relevant content items for users. Content items that are relevant for a user can be recommended through a video interface that is being accessed using a computing device of the user. In some embodiments, the content items are categorized into one or more categories (e.g., live content items to which a user has subscribed, live content items from the user's social network, suggested live content items, live content items organized into topics of interest, etc.). In such embodiments, such categorized content items can be presented through the video interface for the user to access. In some embodiments, content items included in a category are ranked based on various criteria so that more relevant content items in the category are shown before other content items in the category.

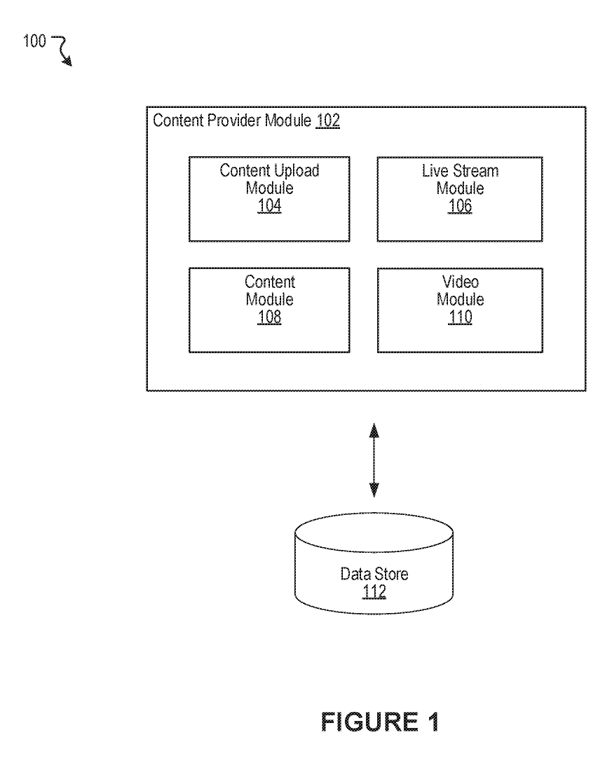

FIG. 1 illustrates an example system 100 including an example content provider module 102 configured to provide access to various content items, according to an embodiment of the present disclosure. As shown in the example of FIG. 1, the content provider module 102 can include a content upload module 104, a live stream module 106, a content module 108, and a video module 110. In some instances, the example system 100 can include at least one data store 112. The components (e.g., modules, elements, etc.) shown in this figure and all figures herein are examples only, and other implementations may include additional, fewer, integrated, or different components. Some components may not be shown so as not to obscure relevant details.

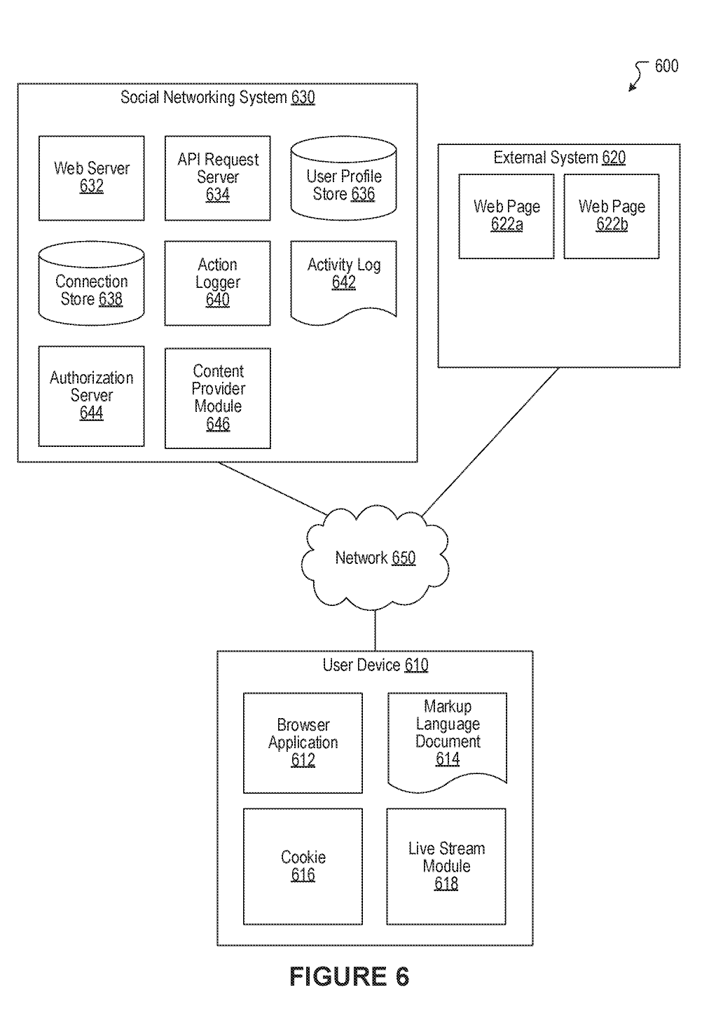

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 or at least a portion thereof can be implemented as or within an application (e.g., app), a program, or an applet, etc., running on a user computing device or a client computing system, such as the user device 610 of FIG. 6. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6.

The content provider module 102 can be configured to communicate and/or operate with the at least one data store 112, as shown in the example system 100. The at least one data store 112 can be configured to store and maintain various types of data. For example, the data store 112 can store information describing various content that is being streamed live through the social networking system and/or on-demand content items (e.g., content items that have been posted by users of the social networking system). In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

The content module 108 can be configured to provide users with access to content items that are posted, or made available, through a social networking system. Such content items may include on-demand content items (e.g., video on-demand or “VOD”) as well as content that is being streamed live. For example, a user can interact with an interface that is provided by a software application (e.g., a social networking application) running on a computing device of the user. This interface can include an option for posting, or uploading, content items to the social networking system. When posting a content item, the content upload module 104 can be utilized to communicate data corresponding to the content item from the computing device to the social networking system. Such content items may include text, images, audio, and videos, for example. The social networking system can then provide the content item through the social networking system including, for example, in one or more news feeds. In some embodiments, the interface can also include an option for live streaming content through the social networking system. When initiating a live content stream, the live stream module 106 can be utilized to communicate data (e.g., audio data, video data, etc.) corresponding to the content to be streamed live from the computing device and through the social networking system. The live stream module 106 can utilize any generally known techniques that allow for live streaming of content including, for example, the Real Time Messaging Protocol (RTMP). In various embodiments, the computing device from which the live content stream is being provided can be equipped to capture data (e.g., video data, audio data, etc.) corresponding to the live content stream.

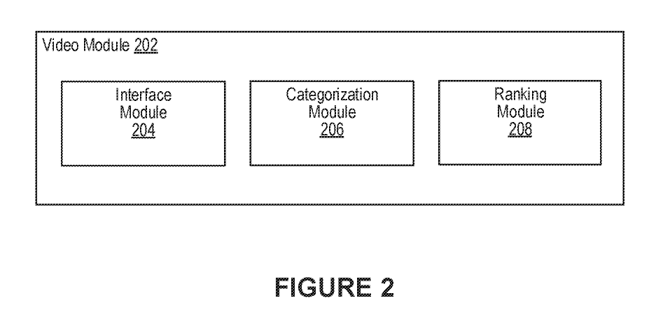

In some embodiments, a user can interact with a video interface to access various videos that are available through the social networking system. This video interface can present various videos that were determined to be relevant to the user by the video module 110. As mentioned, these content items can be categorized into one or more categories. Further, the video module 110 can rank content items included in a given category based on various criteria. More details regarding the video module 110 will be provided below with reference to FIG. 2.

FIG. 2 illustrates an example of a video module 202, according to an embodiment of the present disclosure. In some embodiments, the video module 110 of FIG. 1 can be implemented as the video module 202. As shown in FIG. 2, the video module 202 can include an interface module 204, a categorization module 206, and a ranking module 208.

In various embodiments, the video module 202 can utilize the interface module 204 to provide users with access to various on-demand and/or live content items. The interface module 204 can be configured to provide an interface (e.g., graphical user interface) through which the content items can be presented and accessed. For example, the interface can be provided through a software application running on a computing device being operated by a user. The user can interact with the interface to access content items, for example, by performing touch screen gestures through a display screen of the computing device.

As mentioned, in some embodiments, the content items are organized into categories and such categories of content items can be accessed through the interface. In some embodiments, the categories of content items are ordered. For example, the interface can present a content feed that includes at least a portion of content items from a first category followed by at least a portion of content items from a second category. In this example, the user can scroll through the content feed to access the first and second categories of content items. In some embodiments, when presenting a content item in the content feed, the interface can present a snippet (e.g., a snapshot of a frame or a clip made up of a set of frames) of the content item to allow the user to visualize the content item without having to access (e.g., play) the content item. In some embodiments, content items included in a particular category (e.g., live content items) may automatically begin playing in the content feed without having the user perform any actions. In such embodiments, the content items being played can remain muted (i.e., no sound corresponding to the content items is played) until the user actually accesses, or selects, a content item.

The categorization module 206 is configured to categorize live content items into various categories. Depending on the implementation, such live content items can include content items that are actively being streamed live while the user accesses the interface, content items that were recently streaming live within some pre-defined duration of time from the time the user accesses the interface, or both. In some embodiments, the categorization module 206 separately categorizes live content items that were produced by entities to which the user has subscribed into a first category. For example, the user can subscribe to a given entity by selecting a subscribe option through the social networking system. Once subscribed, new live content items that are posted, or produced, by the entity can be included in the first category.

In some embodiments, live content items that originate from entities in the user's social network can be included in a second category. For example, live content items that were posted, or produced, by the user's social connections (e.g., friends), as recognized by the social networking system, can be included in the second category. In another example, live content items that were posted to pages with which the user has previously interacted can also be included in the second category. For example, users can access various pages through the social networking system and each page can correspond to some entity (e.g., individual, group, topic, etc.). In some embodiments, a user can interact with a page by liking the page (e.g., by selecting a like option through the social networking system), reacting to the page (e.g., by selecting a reaction option through the social networking system), posting a comment in the page through the social networking system, and/or sharing the page with social connections through the social networking system, to name some examples.

In some embodiments, live content items to be suggested to the user are grouped together in a third category. Content to be suggested can include live content items that are trending, live content items that were viewed by the user's social connections, live content items that were liked by the user's social connections, live content items that originate from entities to which the user's social connections have subscriptions, or live content items that are similar to live content items that were liked (or subscribed to) by the user's social connections, to name some examples. In some embodiments, a live content item is trending when a threshold number of users have viewed the live content item for a pre-defined duration of time (e.g., a pre-defined number of seconds, minutes, etc.). In some embodiments, content included in the third category is posted by users, or entities, of the social networking system with which the user has no social connection or association.

In some embodiments, the categorization module 206 is configured to group content items into topical categories based on their respective topics (e.g., sports, entertainment, etc.). For example, if the subject matter of a given content item generally relates to sports, then the content item can be included in the sports category. In some embodiments, a trained machine learning model (e.g., content classifier) is used to categorize the content items into appropriate topical categories. In such embodiments, the model can evaluate the subject matter captured in a content item to predict one or more topics that relate to the content item. In some embodiments, a topical category of content items is presented in the interface only after the user has demonstrated an interest in the topic. In such embodiments, the user can demonstrate an interest in the topic by selecting a corresponding topic tag through the interface, by accessing a threshold amount (e.g., number, percentage, etc.) of content items that relate to the topic, and/or by accessing content items that relate to the topic at a pre-defined frequency.

In some embodiments, live content items that are available through the social networking system and that are not included in any of the other categories are grouped together in a fourth category. For example, content included in the fourth category can include live content items that were posted by various publishers to which the user has not subscribed and has no social connection. The categories of content items, as described above, are provided merely as examples and, naturally, the content items may be organized into categories of various granularity as appropriate and depending on the implementation. Further, the categories described above may be merged or further divided into sub-categories.

In some embodiments, the categories described above can be used to organize on-demand content items that are available through the social networking system. In some embodiments, both live content items and on-demand content items can both be included in the various categories, for example, as described above. In some embodiments, a category is presented in the interface only when a threshold number of content items are included in the category. In some embodiments, the order in which the categories are presented can vary. For example, in some embodiments, a first category that includes content items that were determined to be more relevant for a user can be ranked higher than a second category that includes content items that were determined to be less relevant for the user. In some embodiments, the order in which some categories of content items are presented in the interface remains static while the ordering of the remaining categories is adjusted. For example, a category that includes live content items that were produced by entities to which the user has subscribed can always be presented first in the interface while the order of the remaining categories is adjusted, for example, based on the relevancy of their respective content items. In some embodiments, one or more categories for a user can be determined based on information describing the user, for example, in a social graph. Some examples of such information can include user subscriptions, liked pages, friends that have conducted live broadcasts, videos viewed by friends (e.g., social context), topics liked by the user, geographic locations visited by the user, to name some examples.

In various embodiments, the ranking module 208 is configured to rank content items within the different categories, for example, based on their respective relevancy to a given user. In some embodiments, content items in a category are ranked for a user based on the user's geographic location (e.g., zip code, city, state, country, continent, or any arbitrary definition of a geographic region). For example, content items that are popular among other users that share the user's geographic location can be ranked higher in the category than content items that are less popular among the users. The popularity score of a content item can be measured, for example, based on a threshold amount (e.g., number, percentage, etc.) of users in the geographic region having accessed (e.g., viewed) the content item. In some embodiments, the popularity score of the content item is determined based on a threshold amount (e.g., number, percentage, etc.) of users in the geographic region having accessed (e.g., viewed) the content item for a threshold period of time (e.g., 30 seconds, 1 minute, etc.). In some embodiments, content items in a category are ranked based on geographic locations that have been visited by the user in the past (e.g., past week, month, year, etc.). For example, content items that are popular among other users in a geographic location previously visited by the user can be ranked higher in the category than other content items. In another example, content items that are popular among other users in a geographic location at which the user previously checked-in through the social networking system can be ranked higher in the category than other content items. In some embodiments, content items in a category are ranked based on the user's demographics (e.g., age, gender, country, etc.). For example, content items that are popular among other users that share the user's demographics can be ranked higher in the category than content items that are less popular among the users.

In some embodiments, content items in a category can be ranked based on the entity from which the content items originate. For example, a content item that was posted by an entity to which more users are subscribed can be ranked higher than a content item that was posted by an entity to which fewer users are subscribed. In some embodiments, content items originating from a first entity can be ranked higher than content items originating from a second entity when the first entity posts content items more frequently than the second entity. In some embodiments, content items in a category can be ranked based on their respective trending measurements. For example, a first content item that is determined to be trending more than a second content item can be ranked higher than the second content item. In some embodiments, the ranking of trending content items in a category can be refined based on the user demographics for which those content items are trending. For example, content items that are trending among users that share the user's demographics can be ranked higher than other content items that are trending among the general population. In some embodiments, live content items in a category can be ranked based on the number of users that are accessing the live content item during streaming. For example, if more users are accessing a first live content stream than a second live content stream, then the first live content stream can be ranked higher than the second live content stream. In some embodiments, content items that relate to a particular on-going event (e.g., breaking news, election, etc.) can be ranked higher than other content items. In some embodiments, content items can be ranked based on the time of day. For example, if the user often accesses content in the social networking system for a shorter period of time during one portion of the day (e.g., lunch time), then content items that are shorter in length (e.g., based on some threshold length cutoff) can be ranked higher than content items of a longer duration during this portion of the day. In another example, if the user often accesses content in the social networking system for a longer period of time during a different portion of the day (e.g., during commuting times), then content items that are longer in length (e.g., based on some threshold length cutoff) can be ranked higher than content items of a shorter duration during this portion of the day.

As mentioned, in various embodiments, content items can be analyzed using a trained machine learning model (e.g., content classifier) to determine any topics that relate to the content items. In some embodiments, the content classifier determines a probability indicating whether a content item includes predetermined subject matter (e.g., identities, or names, of individuals, objects, activities, products, logos, animals, points of interest, or other concepts). The content classifier can be based on any machine learning technique, including but not limited to a deep convolutional neural network. The content classifier can be trained and tested to determine the various subject matter that is reflected in a given content item. In some embodiments, topics relating to a content item can be determined by analyzing subtitles (or captions) describing the audio of the content item. In some embodiments, topics relating to a content item can be determined by analyzing any comments posted by users through the social networking system in response to the content item. In one example, user comments may be evaluated based on keyword frequency.

In some embodiments, the content classifier is trained to identify objectionable content (e.g., nudity, profanity, etc.). In such embodiments, content items that include any objectionable content can identified and be made inaccessible to users. In some embodiments, objectionable content in a content item can be identified by analyzing any subtitles (or captions) describing the audio of the content item. In some embodiments, objectionable content in a content item can be identified by analyzing any comments posted by users in response to the content item. In such embodiments, the portion of objectionable content in a live content item may be identified based on the respective times at which the comments were posted.

In some embodiments, reactions selected by users through the social networking system in response to content items can be used to categorize content items into mood-based categories. In another example, user comments may be evaluated using one or more sentiment analysis techniques to categorize content items into mood-based categories.

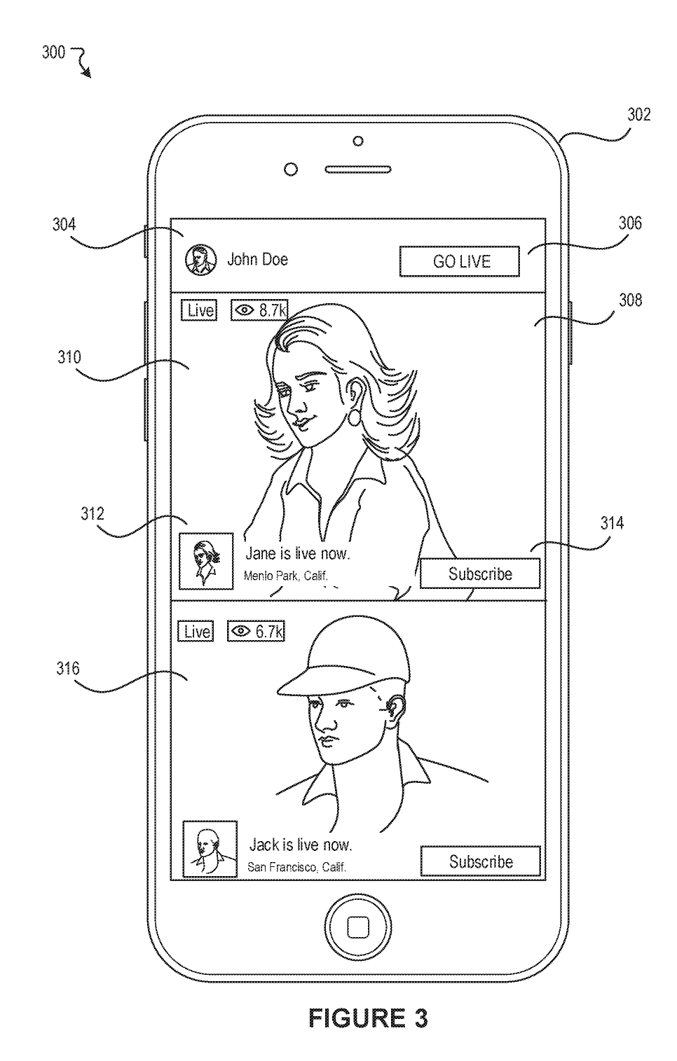

FIG. 3 illustrates an example 300 of an interface 304 for presenting content items, according to an embodiment of the present disclosure. The interface 304 is presented on a display screen of a computing device 302. The interface 304 may be provided through an application (e.g., a web browser, a social networking application, etc.) running on the computing device 302. In this example, the interface 304 includes a content feed 308. As mentioned, the content feed 308 can present various content items that have been organized into categories. For example, the content feed 308 can present one or more content items from a first category followed by one or more content items from a second category. The user operating the computing device 302 can scroll through the content feed 308, for example, using a scroll gesture, to access the different categories of content items. In the example of FIG. 3, the content feed 308 includes live content items 310 and 316. The user can select a subscribe option 314 to subscribe to content items that are posted by the entity “Jane”. In some embodiments, the user can select an option 312 (e.g., profile image of the entity) to access a content feed in which only content items that were posted by the entity “Jane” are presented. In some embodiments, when presenting a content item in the content feed 308, the interface can present a snippet (e.g., a snapshot of a frame or a clip made up of a set of frames) of the content item to allow the user to visualize the content item without having to access (e.g., play) the content item. In some embodiments, content items included in a particular category (e.g., live content items) may automatically begin playing in the content feed without having the user perform any actions. In such embodiments, the content items being played can remain muted (i.e., no sound corresponding to the content items is played) until the user actually accesses, or selects, a content item. The interface 304 also includes an option 306 that the user operating the computing device 302 can select to begin broadcasting a live content stream through the social networking system.

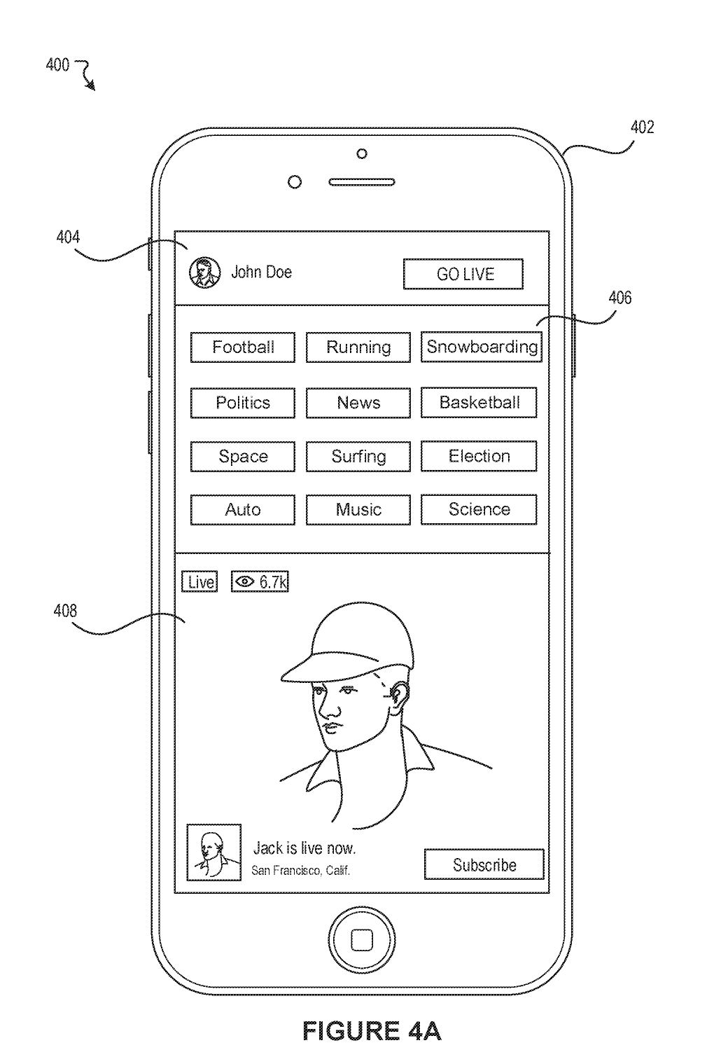

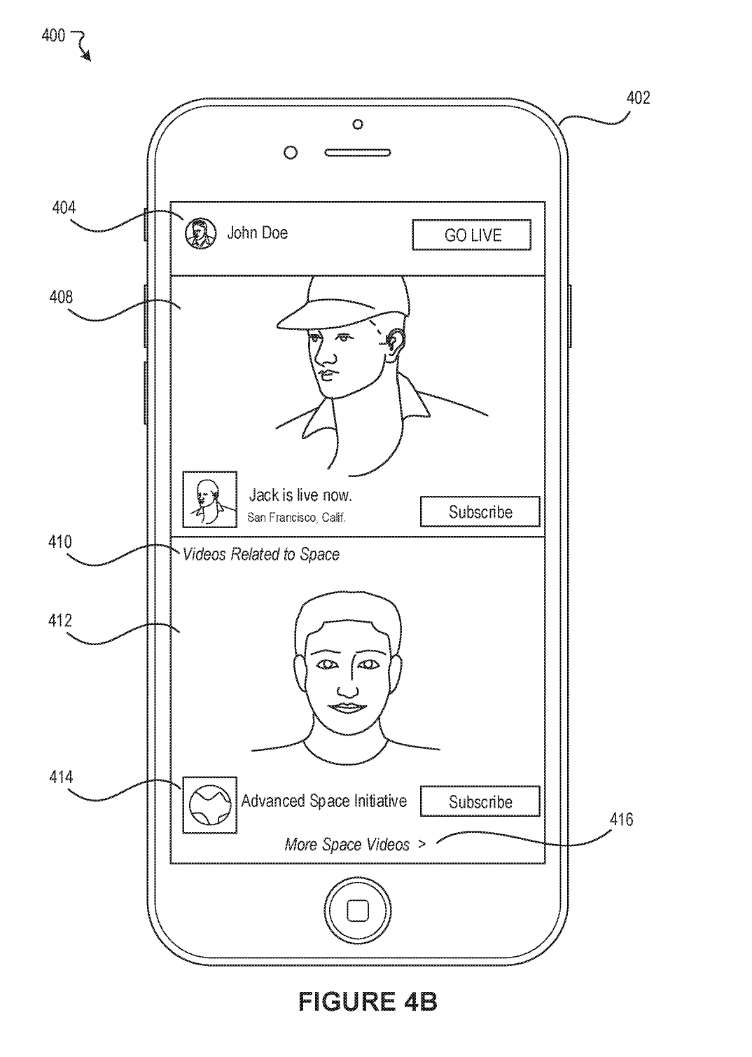

FIG. 4A illustrates an example 400 of an interface 404 for presenting content items, according to an embodiment of the present disclosure. The interface 404 is presented on a display screen of the computing device 402. The interface 404 may be provided through an application (e.g., a web browser, a social networking application, etc.) running on the computing device 402. In this example, the interface 404 includes a set of options 406 that correspond to various topics. In some embodiments, the set of options 406 can be presented at the beginning of a content feed being presented through the interface 404. As mentioned, the content feed can present various content items 408 that have been organized into categories. In the example of FIG. 4A, the user operating the computing device 402 can select one or more of the options 406 to identify topics that are of interest to the user. Upon selecting a topic, the social networking system can provide a category of content items relating to the selected topic for presentation in the content feed. In this example, the user operating the computing device 402 has selected the “Space” topic to be of interest. As a result, a category of content items relating to Space can be included in the content feed, as illustrated in the example of FIG. 4B. In FIG. 4B, the user has navigated, or scrolled, the content feed to view additional content items. Upon scrolling, the user is able to view a category 410 of content items relating to Space. The category 410 includes a content item 412 that is included in the Space category. As mentioned, one or more content items from a given category may be shown in the interface 404 and these content items may be ranked, as described above. In some embodiments, the user can select an option 414 (e.g., profile image of the entity that posted the content item 412) to access a content feed in which only content items that were posted by the entity are shown. In some embodiments, the user can select an option 416 to view other content items that are included in the Space category. The user also has the option to continue scrolling the content feed to view additional categories of content items.

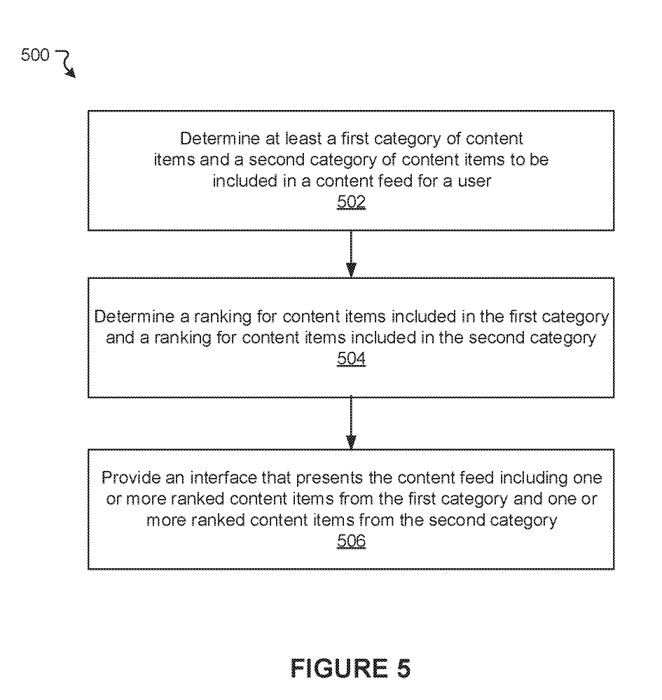

FIG. 5 illustrates an example process 500 for providing content items, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 determines at least a first category of content items and a second category of content items to be included in a content feed for a user. At block 504, a ranking for content items included in the first category is determined and a ranking for content items included in the second category is also determined. At block 506, an interface that presents the content feed including one or more ranked content items from the first category and one or more ranked content items from the second category is provided.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. In some embodiments, the user device 610 can include a live stream module 618. The live stream module 618 can, for example, be implemented as the live stream module 106 of FIG. 1. As discussed previously, it should be appreciated that there can be many variations or other possibilities.

### Hardware Implementation

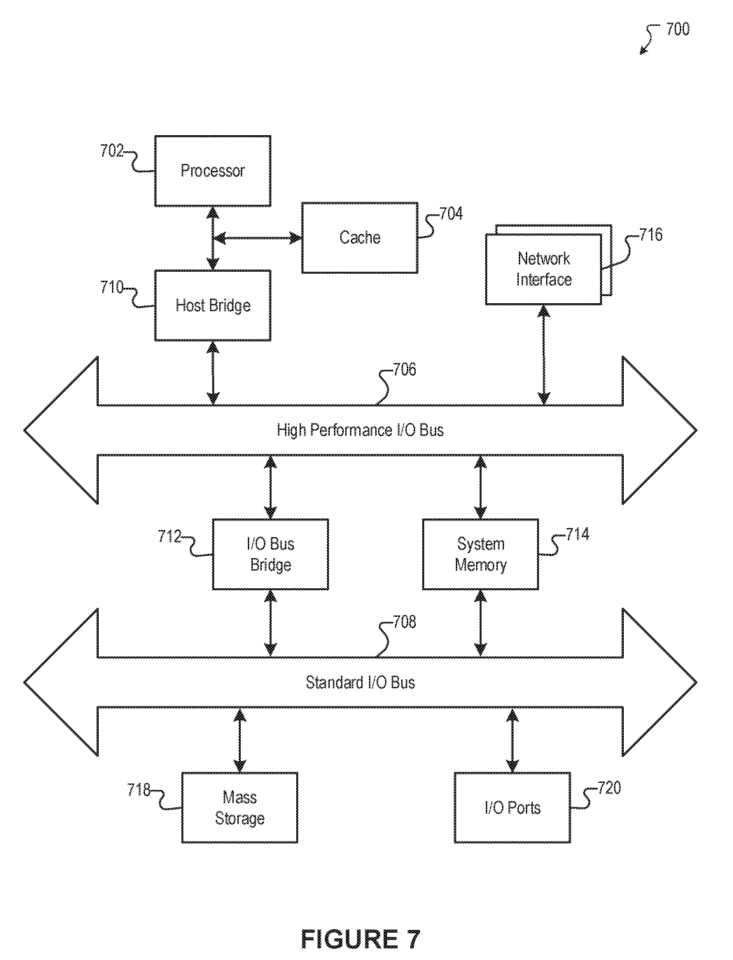

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, at least a first category of content items and a second category of content items to be included in a content feed for a user;
determining, by the computing system, a ranking of content items included in the first category and a ranking of content items included in the second category; and
providing, by the computing system, an interface that presents the content feed including one or more ranked content items from the first category and one or more ranked content items from the second category.

2. The computer-implemented method of claim 1, wherein content items included in the first category are at least one of live content items that are being broadcasted through a social networking system, live content items produced by entities to which the user has subscribed, on-demand content items that were previously live content items, on-demand content items that were not previously live content items, or any combination thereof.

3. The computer-implemented method of claim 1, wherein the first category is determined based on information describing the user in a social graph.

4. The computer-implemented method of claim 1, wherein determining a ranking of content items in a category further comprises:
determining, by the computing system, a respective popularity for each content item included in the category among users that share a geographic region with the user; and
determining, by the computing system, an ordering for the content items in the category based at least in part on the respective popularities.

5. The computer-implemented method of claim 1, wherein determining a ranking of content items in a category further comprises:
determining, by the computing system, a respective popularity for each content item included in the category among users located in at least one geographic region that was previously visited by the user; and
determining, by the computing system, an ordering for the content items in the category based at least in part on the respective popularities.

6. The computer-implemented method of claim 1, wherein determining a ranking of content items in a category further comprises:
determining, by the computing system, a respective popularity for each content item included in the category among users that share a set of demographics associated with the user; and
determining, by the computing system, an ordering for the content items in the category based at least in part on the respective popularities.

7. The computer-implemented method of claim 1, wherein determining a ranking of content items in a category further comprises:
determining, by the computing system, a respective popularity of each entity that posted content items that are included in the category; and
determining, by the computing system, an ordering for the content items in the category based at least in part on the respective popularities.

8. The computer-implemented method of claim 7, wherein the popularity of an entity is determined based at least in part on a number of users that have subscribed to the entity through a social networking system.

9. The computer-implemented method of claim 7, wherein the popularity of an entity is determined based at least in part a number of users accessing at least one live content item posted by the entity through a social networking system.

10. The computer-implemented method of claim 1, the method further comprising:
determining, by the computing system, an order in which the first category and second category will be presented in the content feed based at least in part on the respective content items included in the first category and in the second category.

11. A system comprising:
at least one processor; and
a memory storing instructions that, when executed by the at least one processor, cause the system to perform:
determining at least a first category of content items and a second category of content items to be included in a content feed for a user;
determining a ranking of content items included in the first category and a ranking of content items included in the second category; and
providing an interface that presents the content feed including one or more ranked content items from the first category and one or more ranked content items from the second category.

12. The system of claim 11, wherein content items included in the first category are at least one of live content items that are being broadcasted through a social networking system, live content items produced by entities to which the user has subscribed, on-demand content items that were previously live content items, on-demand content items that were not previously live content items, or any combination thereof.

13. The system of claim 11, wherein the first category is determined based on information describing the user in a social graph.

14. The system of claim 11, wherein determining a ranking of content items in a category further causes the system to perform:
determining a respective popularity for each content item included in the category among users that share a geographic region with the user; and
determining an ordering for the content items in the category based at least in part on the respective popularities.

15. The system of claim 11, wherein determining a ranking of content items in a category further causes the system to perform:
determining a respective popularity for each content item included in the category among users located in at least one geographic region that was previously visited by the user; and
determining an ordering for the content items in the category based at least in part on the respective popularities.

16. A non-transitory computer-readable storage medium including instructions that, when executed by at least one processor of a computing system, cause the computing system to perform a method comprising:
determining at least a first category of content items and a second category of content items to be included in a content feed for a user;
determining a ranking of content items included in the first category and a ranking of content items included in the second category; and
providing an interface that presents the content feed including one or more ranked content items from the first category and one or more ranked content items from the second category.

17. The non-transitory computer-readable storage medium of claim 16, wherein content items included in the first category are at least one of live content items that are being broadcasted through a social networking system, live content items produced by entities to which the user has subscribed, on-demand content items that were previously live content items, on-demand content items that were not previously live content items, or any combination thereof.

18. The non-transitory computer-readable storage medium of claim 16, wherein the first category is determined based on information describing the user in a social graph.

19. The non-transitory computer-readable storage medium of claim 16, wherein determining a ranking of content items in a category further causes the computing system to perform:
determining a respective popularity for each content item included in the category among users that share a geographic region with the user; and
determining an ordering for the content items in the category based at least in part on the respective popularities.

20. The non-transitory computer-readable storage medium of claim 16, wherein determining a ranking of content items in a category further causes the computing system to perform:
determining a respective popularity for each content item included in the category among users located in at least one geographic region that was previously visited by the user; and
determining an ordering for the content items in the category based at least in part on the respective popularities.
